(19) United States
(12) Patent Application Publication
(10) Pub. No.: US 2025/0233259 A1
(43) Pub. Date: Jul. 17, 2025

(54) SECONDARY BATTERY

(71) Applicant: SK ON CO., LTD., Seoul (KR)

(72) Inventors: Hae Ryong JEON, Daejeon (KR); Soo Min PARK, Daejeon (KR); Hyung Ju PAIK, Daejeon (KR); Hoemin CHEONG, Daejeon (KR); Won Tae HEO, Daejeon (KR); Sun SHIN, Gwangju-si (KR)

(21) Appl. No.: 18/968,366

(22) Filed: Dec. 4, 2024

(30) Foreign Application Priority Data
Jan. 15, 2024 (KR) 10-2024-0006232

(51) Int. Cl. H01M 50/342; H01M 50/103; H01M 50/15; H01M 50/169; H01M 50/358

(52) U.S. Cl. CPC H01M 50/342; H01M 50/103; H01M 50/15; H01M 50/169; H01M 50/358; H01M 2200/103; H01M 2200/20

(57) ABSTRACT

A secondary battery includes a case that accommodates an electrode assembly; a cap plate sealing an opening of the case and including a first exhaust hole, and having a first polarity; an insulating member disposed on a lower portion of the cap plate and including a second exhaust hole with a larger diameter than the first exhaust hole, and positioned to correspond to the first exhaust hole; a current collecting member disposed on a lower portion of the insulating member and electrically connected to the electrode assembly, and having a second polarity different from the first polarity; a guide member disposed in a lower portion of the second exhaust hole and electrically connected to the current collecting member; and a short-circuit member including a conductive material and disposed in the guide member to move to come into contact with the cap plate in response to pressure generated within the case.

### CROSS-REFERENCE TO RELATED APPLICATION(S)

This patent document claims the priority and benefits of Korean Patent Application No. 10-2024-0006232 filed on Jan. 15, 2024, the disclosure of which is incorporated herein by reference in its entirety.

### TECHNICAL FIELD

The technology and implementations disclosed in this patent document generally relate to a secondary battery.

### BACKGROUND

A secondary battery is a type of energy storage device that may be repeatedly charged and discharged. Secondary batteries are widely used across various applications that rely on electricity as a power source. For example, secondary batteries serve as energy storage in devices ranging from small electronic devices, such as mobile phones, laptops, and tablets, to large devices, such as vehicles and aircraft. Recently, secondary batteries have been actively researched as power sources for vehicles.

### SUMMARY

The disclosed technology can be implemented in some embodiments to provide a secondary battery designed to enhance its stability.

A secondary battery implemented based on some embodiments of the disclosed technology may be widely applied in the field of green technology, such as electric vehicles, battery charging stations, and other battery-utilizing solar power generation schemes, wind power generation schemes, or others. In addition, the secondary battery of the disclosed technology may be used in eco-friendly electric vehicles, hybrid vehicles, and others to prevent climate change by reducing air pollution and greenhouse gas emissions.

In an aspect of the disclosed technology, a secondary battery may include: a case structured to accommodate an electrode assembly therein; a cap plate configured to seal an opening of the case and including a first exhaust hole, the cap plate having a first polarity; an insulating member disposed on a lower portion of the cap plate and including a second exhaust hole positioned to correspond to a position of the first exhaust hole, the second exhaust hole having a larger diameter than the first exhaust hole; a current collecting member disposed on a lower portion of the insulating member electrically connected and to the electrode assembly, the current collecting member having a second polarity that is different from the first polarity; a guide member disposed in a lower portion of the second exhaust hole and electrically connected to the current collecting member; and a short-circuit member including a conductive material and disposed in the guide member, the short-circuit member being configured to move upward to come into contact with the cap plate in response to pressure generated within the case.

The secondary battery may further include an elastic member disposed in the guide member and configured to apply pressure to the short-circuit member from above.

The guide member may include a first body including open upper and lower portions, and a first bottom portion formed to extend in both inward and outward directions from a lower end of the first body. The first bottom portion may be electrically connected to the current collecting member.

The short-circuit member may include a second body having an open upper portion, a second bottom portion formed to extend in an outward direction from a lower end of the second body, and a breakable portion formed in the second body and including a notch.

The short-circuit member may further include a protrusion portion coupled to an outer perimeter of the second body. The insulating member may include an accommodation groove accommodating the protrusion portion when the short-circuit member moves upward.

At least one of the second body or protrusion portion of the short-circuit member may have at least one cutout portion.

An inclined surface may be formed at an upper end of the protrusion portion.

The protrusion portion may include a body portion coupled to an outer perimeter of the second body, and an elastic protrusion portion extending in a downward direction from an upper end of the body portion to be inclined.

In another aspect of the disclosed technology, a secondary battery including: a case structured to accommodate an electrode e assembly therein; a cap plate configured to seal an opening of the case and including a first exhaust hole, the cap plate having a first polarity; an insulating member disposed on a lower portion of the cap plate and including a second exhaust hole positioned to correspond to a position of the first exhaust hole, the second exhaust hole having a larger diameter than the first exhaust hole; a current collecting member disposed on a lower portion of the insulating member and electrically connected to the electrode assembly, the current collecting member having a second polarity that is different from the first polarity; a guide member disposed in a lower portion of the second exhaust hole; a short-circuit member including a conductive material and disposed in the guide member, the short-circuit member being configured to move upward to come into contact with the cap plate in response to pressure generated within the case; and a short-circuit tab including a conductive material and coupled to a lower portion of the short-circuit member, the short-circuit tab being configured to come into contact with the current collecting member when the short-circuit member comes into contact with the cap plate.

A secondary battery based on some embodiments of the disclosed technology may include a short-circuit member performing a short-circuit function when an abnormality occurs, and a breakable portion formed in the short-circuit member to release internal gas. In this way, components can perform their functions without the need for additional components, thereby simplifying the configuration.

However, technical effects achieved by embodiments of the disclosed technology are not necessarily limited to those described in this patent document.

### BRIEF DESCRIPTION OF DRAWINGS

Certain aspects, features, and advantages of the disclosed technology are illustrated by the following detailed description with reference to the accompanying drawings.

FIG. 1 is a schematic external perspective view of a secondary battery based on an embodiment.

FIG. 2 is a cross-sectional view taken along line I-I′ of FIG. 1.

FIG. 3 is a schematic exploded perspective view of members in portion “II” illustrated in FIG. 2.

FIG. 4 is a cross-sectional view of a guide member, a short-circuit member, and an elastic member that are coupled to each other in a secondary battery based on an embodiment.

FIGS. 5 to 7 are cross-sectional views of sequential operations of a short-circuit member in a secondary battery based on an embodiment.

FIG. 8 is a diagram illustrating another embodiment of a short-circuit member in a secondary battery based on an embodiment.

FIG. 9 is a diagram illustrating another embodiment of a short-circuit member in a secondary battery based on an embodiment.

FIGS. 10A and 10B are cross-sectional views of an operation of the short-circuit member of FIG. 9.

FIG. 11 is a diagram illustrating another embodiment of a short-circuit member in a secondary battery based on an embodiment.

FIGS. 12A, 12B, and 12C are cross-sectional views of an operation of the short-circuit member of FIG. 11.

FIGS. 13 to 15 are cross-sectional views of sequential operations of a short-circuit member in a secondary battery based on another embodiment.

### DETAILED DESCRIPTION

Various embodiments disclosed in this patent document are described with reference to the accompanying drawings.

Secondary batteries can be classified into types such as lead-acid batteries, nickel-cadmium batteries, nickel-hydrogen batteries, lithium-ion batteries, depending on the electrode material used. The type of secondary battery is typically selected depending on factors such as design capacity and usage environment. Compared to other types of secondary batteries, lithium-ion batteries offer relatively high voltages and capacities. For these reasons, lithium-ion batteries are widely used in applications requiring high-density energy storage, such as vehicle battery packs.

Secondary batteries, such as lithium-ion batteries, may include a positive electrode, a negative electrode, a separator, and an electrolyte. The positive electrode and the negative electrode are separated by a separator formed of an insulating material. Secondary batteries can be charged or discharged as ions move through the electrolyte between the electrodes.

When excessive heat is generated or the electrolyte decomposes due to overcharging, foreign substance intrusion, or damage to the insulating structure from external impact, internal pressure of secondary batteries may increase, potentially leading to ignition or explosion. To enhance safety, various technical measures have been applied to the cap plate that seals the battery case.

In some embodiments, the term “secondary battery” may be used to indicate rechargeable batteries such as lead-acid batteries, nickel-cadmium batteries, nickel-hydride batteries, and lithium-ion batteries. In some embodiments discussed in this patent document, the term “secondary battery” is used to indicate a lithium-ion battery. In general, lithium-ion batteries offer advantages such as being lightweight, having a high energy density, and exhibiting low self-discharge rate. However, it should be noted that the features that are discussed in this patent document with respect to lithium-ion batteries are also applicable to other types of batteries.

In some embodiments, a secondary battery may include a single physical unit, or a cluster unit including a plurality of physical units combined with each other. For example, a secondary battery may include a battery cell, a battery module, a battery pack, or others depending on the classification criteria generally used in the current vehicle industry. In some embodiments, the secondary battery is a battery cell, a single unit. In some embodiments, a battery cell may be a basic component unit of a battery pack including a positive electrode, a negative electrode, a separator, an electrolyte, and others. However, some embodiments disclosed in this patent document are also applicable to other types of cluster units such as a battery module, a battery pack, and others.

In some embodiments, the secondary battery may encompass various types of packaged secondary batteries. For example, the secondary battery may be packaged in a cylindrical shape, a prismatic shape, a pouch shape, or others depending on the classification criteria commonly used in the field. In some embodiments, the secondary battery may be packaged in a prismatic shape. Prismatic-shaped packaging, referred to as a prismatic-shaped battery, may generally have advantages in terms of durability, safety, and convenience of mounting. However, some embodiments disclosed in this patent document are also applicable to other types of packaging such as a cylindrical-shaped packaging or a pouch-shaped packaging.

In some embodiments, the secondary battery may be used in various applications requiring electrical energy. For example, the secondary battery may be used in vehicles using electrical energy as a main power source or an auxiliary power source. In some embodiments, the secondary battery may be used in fields such as aviation, e.g., personal aircraft, unmanned aerial vehicles, drones, as well as in electronic devices, such as mobile phones, laptops, tablets, and in electric tools, such as electric drills, electric grinders, electric hammers. However, it should be understood that some embodiments discussed in this patent document are also applicable to a wide range of devices powered by electrical energy beyond those mentioned above.

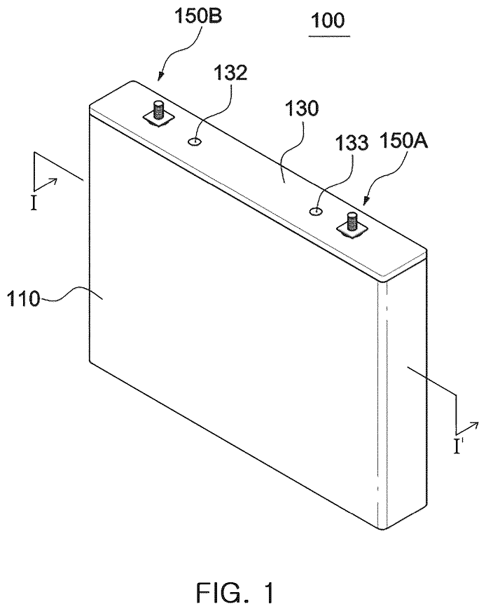

FIG. 1 is a schematic external perspective view of a secondary battery 100 based on an embodiment of the disclosed technology, and FIG. is a cross-sectional view taken along line I-I′ of FIG. 1.

For simplicity, in some embodiments use a single battery cell with a prismatic shape as an example.

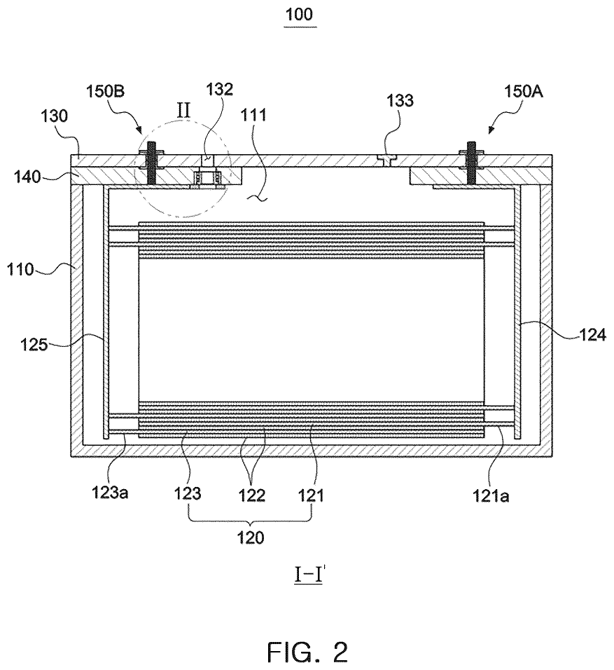

Referring to FIGS. 1 and 2, the secondary battery 100 based on some embodiments may include a case 110.

The case 110 may provide an internal space in which an electrode assembly 120 or the like may be accommodated. In one example, the case 110 has an approximately rectangular parallelepiped shape.

The case 110 may include an opening 111 connected to the internal space. In one example, the opening 111 is disposed in an upper end of the case 110. However, a position of the opening 111 may vary, and is not necessarily limited to this example. The opening 111 may function as a path for inserting the electrode assembly 120. In addition, the opening 111 may function as a connection space for electrical connection between the electrode assembly 120 and an electrode terminal. The opening 111 may be closed or sealed by a cap plate 130.

The material of the case 110 may be appropriately selected in consideration of thermal and electrical conductivity, rigidity corresponding to swelling of the electrode assembly 120, machinability, manufacturing costs. For example, the case 110 may be formed of a metal material including aluminum, an aluminum alloy, or others.

The secondary battery 100 based on an embodiment may include the electrode assembly 120.

The electrode assembly 120 may be disposed in the internal space of the case 110. The electrode assembly 120 may include a first electrode body 121, a separator 122, and a second electrode body 123. In this case, the first electrode body 121 may function as a positive electrode, and the second electrode body 123 may function as a negative electrode. The opposite case may be possible. For simplicity, hereinafter, a case in which the first electrode body 121 functions as a positive electrode will be mainly described.

The first electrode body 121 may include a positive electrode current collector and a positive electrode active material. In some embodiments, the positive electrode current collector may include aluminum, an aluminum alloy, or the like, and the positive electrode active material may include lithium cobalt oxide, lithium manganate, lithium nickel oxide, lithium iron phosphate, or the like. The positive electrode active material may be coated on a surface of the positive electrode current collector. A portion of the positive electrode current collector, not coated with the positive electrode active material, may function as a first tab 121a. In some embodiments, the first tab 121a may be provided as a plurality of first tabs 121a, and a portion or all of the plurality of first tabs 121a may be connected to a first current collecting member 124.

The second electrode body 123 may include a negative electrode current collector and a negative electrode active material. In some embodiments, the negative electrode current collector may include copper, a copper alloy, nickel, a nickel alloy, or the like, and the negative electrode active material may include carbon, silicon, or the like. The negative electrode active material may be coated on a surface of the negative electrode current collector. A portion of the negative electrode current collector, not coated with the negative electrode active material, may function as a second tab 123a. In some embodiments, a plurality of second tabs 123a may be provided, and a portion or all of the plurality of second tabs 123a may be connected to a second current collecting member 125.

The separator 122 may be disposed between the first electrode body 121 and the second electrode body 123. The separator 122 may limit physical contact between the first electrode body 121 and the second electrode body 123, and may function to provide a path for movement of ions. In some embodiments, the separator 122 may be formed of a polymer material including polyethylene, polypropylene, or the like. The separator 122 may include a dry separator and a wet separator. In some embodiments, the separator 122 may include a coating layer including a ceramic coating layer or the like.

The electrode assembly 120 may be formed by arranging the components in a winding or stacking manner. For example, the electrode assembly 120 may be formed to have a structure in which the first electrode body 121, the second electrode body 123, and the separator 122 are wound around an axis in a longitudinal direction or a transverse direction. Alternatively, the electrode assembly 120 may be formed to have a structure in which the winding structure is pressed in a direction, approximately perpendicular to a winding axis. The winding structure may be referred to as a “jelly roll” or the like in the art.

For another example, the electrode assembly 120 may be formed to have a structure in which the first electrode body 121, the second electrode body 123, and the separator 122 are stacked. In some cases, in the stack structure, the separator 122 may be formed to have a structure in which a plurality of unit separators 122, continuous in a length direction, are sequentially folded and stacked based on stacking of the first electrode body 121 and the second electrode body 123. The stack structure may be referred to as “stack and folding” or “z-folding” in the art. However, in some embodiments, arrangements of respective components of the electrode assembly 120 are not limited. The electrode assembly 120 may have various arrangements other than those mentioned above.

In some embodiments, the electrode assembly 120 may be formed by combining a plurality of units with each other. For example, the electrode assembly 120 may include a unit wound in a jelly-roll manner, and two or more units may be combined with each other to form the electrode assembly 120. In some embodiments, the electrode assembly 120 may include two jelly roll units, combined with each other. For another example, the electrode assembly 120 may include a unit wound in a “stack and folding” manner, and two or more units may be combined with each other to form the electrode assembly 120.

The electrode assembly 120 may be accommodated in the internal space of the case 110, together with an electrolyte. In some embodiments, the electrolyte may be formed of an organic solvent including a lithium salt. For example, the lithium salt may include liquid or gel-like lithium hexafluorophosphate (LiPF₆), lithium tetrafluoroborate (LiBF₄), or the like, and the organic solvent may include cyclic carbonate such as ethylene carbonate (EC), propylene carbonate (PC), or the like, linear carbonate such as diethyl carbonate (DEC), dimethyl carbonate (DMC), ethyl methyl carbonate (EMC), or the like, or the like.

In other embodiments, the electrolyte may be omitted or replaced. For example, when an inorganic material-based solid electrolyte is used, a liquid or gel-like electrolyte may be omitted.

The secondary battery 100 based on some embodiments may include a cap plate 130.

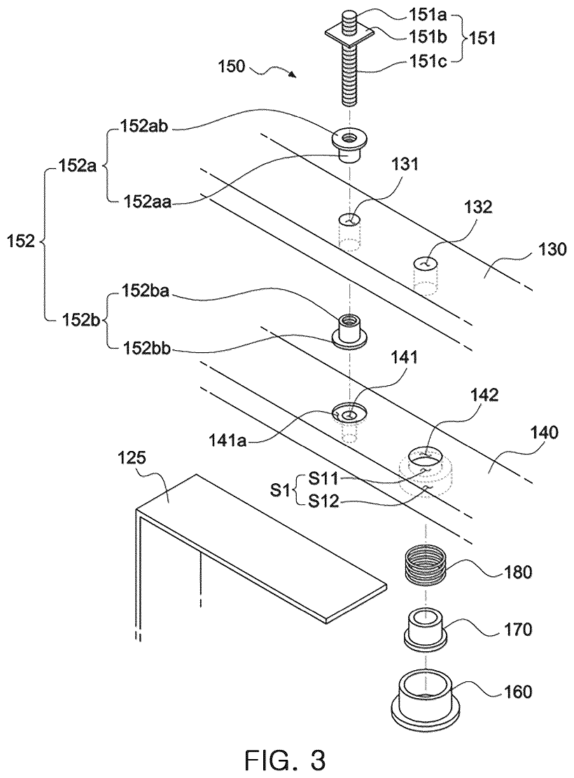

The cap plate 130 may be formed to close the opening 111. In one example, the cap plate 130 has a rectangular plate shape corresponding to that of the opening 111. The cap plate 130 may be coupled to the case 110 to seal the internal space of the case 110 in which the electrode assembly 120 is disposed. In some embodiments, the cap plate 130 may be welded to the case 110 by ultrasonic welding, laser welding, or the like. An electrode terminal 151 (see FIG. 3) may be disposed on the cap plate 130, and the electrode terminal 151 may be electrically connected to the first tab 121a or the second tab 123a of the electrode assembly 120.

The cap plate 130 may include an electrolyte injection port 133. The electrolyte injection port 133 may be used to inject the electrolyte into the internal space of the case 110. In some embodiments, the electrolyte injection port 133 may be disposed in a central region of the cap plate 130, but a position of the electrolyte injection port 133 may be changed in various manners, and is not necessarily limited to the example. The electrolyte injection port 133 may be properly sealed after being subject to injection of the electrolyte, a formation process, or the like. In some embodiments, the electrolyte injection port 133 may be sealed by press-fitting a ball-shaped sealing member formed of a polymer resin. Additional features of the cap plate 130 will be described with reference to other drawings.

The secondary battery 100 based on some embodiments may include a first terminal portion 150A and a second terminal portion 150B. Each of the first terminal portion 150A and the second terminal portion 150B may be disposed on the cap plate 130. The first terminal portion 150A may be electrically connected to the first tab 121a of the electrode assembly 120, and the second terminal portion 150B may be electrically connected to the second tab 123a of the electrode assembly 120. Additional features of the first and second terminal portions 150A and 150B will be described with reference to other drawings.

Hereinafter, a short-circuit function and an internal gas emission function for ensuring stability of the secondary battery 100 will be described in more detail with reference to FIGS. 3 to 15. A guide member 160, a short-circuit member 170, an elastic member 180, and the like to be described below may be installed in a form of being electrically connected to the first terminal portion 150A or the second terminal portion 150B. The former may have a form of being electrically connected to the first current collecting member 124. The latter may have a form of being electrically connected to the second current collecting member 125. Descriptions of other components excluding the above-described components may be the same or similar. Accordingly, for simplicity, a case in which the above-described components are installed in a form of being electrically connected to the second terminal portion 150B will be mainly described.

FIG. 3 is a schematic exploded perspective view of members in portion “II” illustrated in FIG. 2. FIG. 3 mainly illustrates the second terminal portion 150B illustrated in FIG. 2. For simplicity, the second terminal portion 150B will be referred to as a terminal portion 150, and the second current collecting member 125 will be referred to as a current collecting member 125.

Referring to FIG. 3, the secondary battery 100 based on some embodiments may include a case 110, a cap plate 130, an insulating member 140, a terminal portion 150, a guide member 160, and a short-circuit member 170.

The case 110 has been described above, and thus a repeated description thereof will be omitted.

The cap plate 130 may be coupled to the case 110 to seal the opening 111 of the case 110, as described above. A first terminal hole 131 may be formed in the cap plate 130. In addition, a first exhaust hole 132 may be additionally formed in the cap plate 130. The first exhaust hole 132 may serve as a path through which gas, generated in the case 110, is externally discharged so that the gas inside the case 110 can be released outside of the case 110.

The insulating member 140 may be disposed on a lower portion of the cap plate 130, and may insulate the cap plate 130 and the electrode terminal 151 from each other, thereby preventing an unnecessary electrical short-circuit from occurring. A material, included in the insulating member 140, may be a material having insulating properties, and is not limited. A second terminal hole 141 may be formed in the insulating member 140. A position of the second terminal hole 141 may be formed to correspond to that of the first terminal hole 131 formed in the cap plate 130. That is, in a state in which the insulating member 140 is disposed on a lower portion of the cap plate 130, the first terminal hole 131 and the second terminal hole 141 may be formed to correspond to each other by aligning with each other so that the aligned first terminal hole 131 and the second terminal hole 141 collectively form a through hole to receive the electrode terminal 151. A second exhaust hole 142 may be additionally formed in the insulating member 140. In this case, a position of the second exhaust hole 142 may be formed to correspond to, or to align with, that of the first exhaust hole 132 formed in the cap plate 130. That is, in the state in which the insulating member 140 is disposed on the lower portion of the cap plate 130, the first exhaust hole 132 and the second exhaust hole 142 may be formed to correspond to each other by aligning with each other so that the aligned the first exhaust hole 132 and the second exhaust hole 142 collectively form an exhaust hole to allow the gas generated inside the case 110 to be released outside of the case 110. In addition, the second exhaust hole 142 may be formed to have a diameter greater than that of the first exhaust hole 132. Accordingly, in the state in which the insulating member 140 is disposed on the lower portion of the cap plate 130, in a bottom view of second exhaust hole 142, a region, adjacent to the first exhaust hole 132 and the first exhaust hole 132 of the cap plate 130, may be exposed on an edge of the second exhaust hole 142. In addition, an internal space S1 of the insulating member 140 communicating with the second exhaust hole 142 may include a first space S11 having a diameter equal to or similar to that of the second exhaust hole 142, and a second space S12 having a diameter greater than that of the second exhaust hole 142. The two spaces S11 and S12 may communicate with each other to form a single space S1. However, a wall portion 143 (see FIG. 5) may be formed to be adjacent to the second exhaust hole 142 due to a difference in diameter between the two spaces S11 and S12. In this case, the wall portion 143 may have a side surface 143a toward the first space S11, and a lower surface 143b toward the second space S12 (see FIGS. 5 to 7).

The terminal portion 150 may include an electrode terminal 151, a gasket 152, and a current collecting member 125.

The electrode terminal 151 may pass through the cap plate 130 and be coupled to the cap plate 130 so as to protrude and extend to upper and lower portions of the cap plate 130 by a predetermined length. Specifically, the electrode terminal 151 may sequentially pass through and couple the first terminal hole 131, formed in the cap plate 130, and the second terminal hole 141, formed in the insulating member 140, with respect to FIG. 3. It is illustrated that the electrode terminal 151 has a rod shape having a thread formed on an outer perimeter thereof, but the disclosed technology is not limited thereto. The electrode terminal 151 may be coupled to the current collecting member 125 below the cap plate 130 to be electrically coupled to the electrode assembly 120. A coupling method is not limited, and for example, a method such as riveting or caulking may be applied thereto. The electrode terminal 151 may be selected from copper, a copper alloy, an aluminum alloy, and an equivalent thereof, depending on a polarity thereof, but the disclosed technology is not limited thereto. For example, in a case in which the current collecting member 125 functions as a negative electrode, the electrode terminal 151 connected thereto may be selected from copper, a copper alloy, and an equivalent thereof, but the disclosed technology is not limited thereto.

The electrode terminal 151 may include a flange portion 151b formed to extend in a horizontal direction from one side of a body thereof. A body upper portion 151a, corresponding to an upper portion of the body with respect to the flange portion 151b, may be exposed to an upper region of the cap plate 130 when the electrode terminal 151 is coupled to the cap plate 130. A body lower portion 151c, corresponding to a lower portion of the body with respect to the flange portion 151b, may be coupled to the cap plate 130, the insulating member 140, the current collecting member 125, and the like without being externally exposed.

The gaskets 152 may be interposed between the first terminal hole 131 and the second terminal hole 141, corresponding to each other. The gasket 152 may seal a space between the electrode terminal 151 and the cap plate 130, and a space between the electrode terminal 151 and the insulating member 140. The gasket 152 may prevent external moisture from permeating into the secondary battery 100, or may prevent an electrolyte accommodated in the secondary battery 100 from flowing out.

In an embodiment, the gasket 152 may include a first gasket 152a and a second gasket 152b. The first gasket 152a may include a first body 152aa inserted from above the first terminal hole 131, and a first extension portion 152ab formed to extend in the horizontal direction from an upper end of the first body 152aa to seal a space between the electrode terminal 151 and the cap plate 130. In this case, although not illustrated in the drawings, a groove portion, accommodating the flange portion 151b of the electrode terminal 151, may be formed in the first extension portion 152ab. The groove portion may prevent rotation of the flange portion 151b to stably fix the electrode terminal 151. The second gasket 152b may include a second body 152ba inserted from below the first terminal hole 131, and a second extension portion 152bb formed to extend in the horizontal direction from a lower end of the second body 152ba to seal a space between the electrode terminal 151 and the cap plate 130. A groove portion 141a, accommodating the second extension portion 152bb of the second gasket 152b, may be formed in the second terminal hole 141 of the insulating member 140. The groove portion 141a may accommodate the second extension portion 152bb of the second gasket 152b to prevent rotation of the second extension portion 152bb, thereby stably fixing the second gasket 152b to the insulating member 140.

The current collecting member 125 may be electrically connected to the electrode assembly 120 and installed in the case 110, as described above. In this case, when the cap plate 130 has a first electrical polarity, the current collecting member 125 may have a second electrical polarity that is different from the first polarity (e.g., opposite to the first electrical polarity) to ensure a desired direction of the electric current. For example, the cap plate 130 may have a positive electrical polarity, and the current collecting member 125 may have a negative electrical polarity, or vice versa. Although not illustrated in the drawings, the current collecting member 125 may be electrically connected to a fuse portion (not illustrated). For example, the fuse portion may be disposed on the current collecting member 125. The fuse portion may be melted to block a flow of the current when the current collecting member 125 is overheated above a preset temperature. The fuse portion may be implemented in various ways, including fuse designs commonly used in the present technical field.

The guide member 160 may be installed in a lower portion of the second exhaust hole 142. Specifically, the guide member 160 may be installed in the second space S12 of the insulating member 140. The guide member 160 may be formed of a conductive material, and a type of material is not limited.

The short-circuit member 170 may be disposed in the guide member 160 in a movable manner so that the short-circuit member 170 may move in position relative to the guide member 160. The short-circuit member 170 may be in contact with, and electrically connected to, the guide member 160. In the same manner as the guide member 160, the short-circuit member 170 may be formed of a conductive material, and a type of material is not limited. The guide member 160 and the short-circuit member 170 may be formed of the same type of conductive material or the different types of conductive material.

The secondary battery 100 based on some embodiments may further include an elastic member 180. The elastic member 180 may be installed in the guide member 160 above the short-circuit member 170 to press the short-circuit member 170 from above. For example, the elastic member 180 may include a spring. In this case, physical properties, such as elastic force of the spring, may have a predefined or preset range.

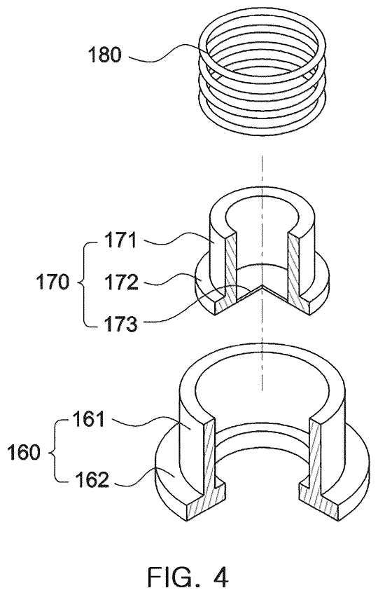

The guide member 160, the short-circuit member 170, and the elastic member 180 will be additionally described with reference to other drawings. In connection therewith, FIG. 4 is a cross-sectional view of a guide member 160, a short-circuit member 170, and an elastic member 180 are coupled to each other in a secondary battery based on an embodiment of the disclosed technology where the short-circuit member 170 is movably placed in contact with and inside of the guide member 160 along with the elastic member 180 that is inside of the guide member 160 and is on top of the short-circuit member 170. For simplicity, other components may be omitted from the drawings.

Referring to FIG. 4, the guide member 160 may include a first body 161 with a hollow structure having open upper and lower portions, and a first bottom portion 162 formed to extend in inward and outward directions from a lower end of the first body 161. In this case, a portion of the first bottom portion 162, formed to extend in an outward direction from the lower end of the first body 161, may be electrically connected to the current collecting member 125. A portion of the first bottom portion 162, formed to extend in an inward direction from the lower end of the first body 161, may support the short-circuit member 170. The inside of the first body 161 may function as a movement path of gas or the like generated in the case 110.

The short-circuit member 170 may include a second body 171 with a hollow structure having an open upper portion, a second bottom portion 172 formed to extend in an outward direction from a lower end of the second body 171, and a breakable portion 173 formed in the second body 171. The short-circuit member 170 may be inserted into the first body 161 of the guide member 160 to be movable inside the first body 161 of the guide member 160, and may be supported by a portion of the first bottom portion 162 formed on the inside of the lower end of the first body 161. A height of the short-circuit member 170 may be determined within a range in which an upper end of the short-circuit member 170 is not in contact with a lower surface of the cap plate 130, when the short-circuit member 170 is inserted into the guide member 160. In an example, when the short-circuit member 170 is inserted into the guide member 160, the height of the short-circuit member 170 may be determined such that an upper end of the short-circuit member 170 and an upper end of the guide member 160 approximately correspond to each other, but the disclosed technology is not limited thereto. The breakable portion 173 may be formed to be parallel to the second bottom portion 172 in the second body 171. In the drawing accompanying in connection therewith, it is illustrated that the breakable portion 173 is formed on an inner lower end of the second body 171, but the disclosed technology is not limited thereto. The breakable portion 173 may have a notch. The notch may be formed to induce the breakage of the breakable portion 173 corresponding to the internal pressure of the case 110. A shape of the notch is not limited, and a notch shape, commonly used in the present technical field, may be applied.

The elastic member 180 may be installed in a space provided between the inside of the first body 161 of the guide member 160 and the outside of the second body 171 of the short-circuit member 170. In this case, an upper portion of the elastic member 180 may be supported by the lower surface 143b of the wall portion 143 (see FIG. 5) of the insulating member 140, and a lower portion of the elastic member 180 may be supported by the second bottom portion 172 of the short-circuit member 170.

Hereinafter, an operation of the short-circuit member 170 in the secondary battery 100 based on some embodiments will mainly be described.

FIGS. 5 to 7 are cross-sectional views of sequential operations of the short-circuit member 170 in the secondary battery 100 based on an embodiment of the disclosed technology.

Referring to FIG. 5, as described above, the guide member 160, the short-circuit member 170, and the elastic member 180 may be installed in a lower portion of the second exhaust hole 142 of the insulating member 140. In this case, the first bottom portion 162 of the guide member 160 may be maintained in a state of being electrically connected to the current collecting member 125. For example, the first bottom portion 162 may be in a state of being in contact with or connected to the current collecting member 125. The short-circuit member 170 may be maintained in a state in which the short-circuit member 170 is pressed by the elastic member 180, and an upper end of the short-circuit member 170 may be maintained in a state of being spaced apart from a lower surface of the cap plate 130. The short-circuit member 170 may be electrically connected to the guide member 160.

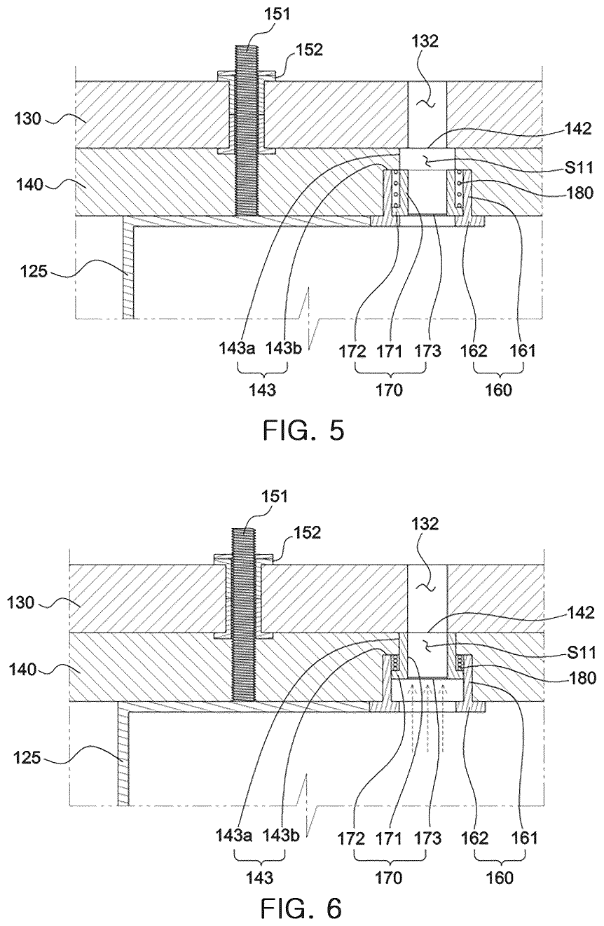

Referring to FIG. 6, when internal pressure of the case 110 excessively increases, gas or the like, generated in the case 110, may flow into an open portion of a lower portion of the guide member 160. In this case, when pressure, such as gas or the like, exceeds force of the elastic member 180 pressing the short-circuit member 170, the short-circuit member 170 may start to move up or rise due to the net upward pressure. Accordingly, this upward movement of the short-circuit member 170 causes the elastic member 180 to be compressed in proportion to the rise of the short-circuit member 170. Subsequently, as the pressure generated in the case 110 increases, the movable short-circuit member 170 may continue to rise up until an upper end of the short-circuit member 170 comes into contact with a lower surface of the cap plate 130 exposed to the second exhaust hole 142. Under this condition, the current collecting member 125, the guide member 160, and the short-circuit member 170 may all be electrically connected to each other. When the current collecting member 125 and the cap plate 130 may be designed to have different electrical polarities, a short-circuit condition may be induced when the upper end of the short-circuit member 170 comes into contact with the lower surface of the cap plate 130. Furthermore, when the short-circuit is induced, a large amount of the current may temporarily flow through the short circuit portion, thereby generating excessive heat. When the temperature of a fuse portion formed on the current collecting member 125 or electrically connected to the current collecting member 125 exceeds a melting temperature due to the heat generated, the fuse portion may be melted to stop or block the flow of the current.

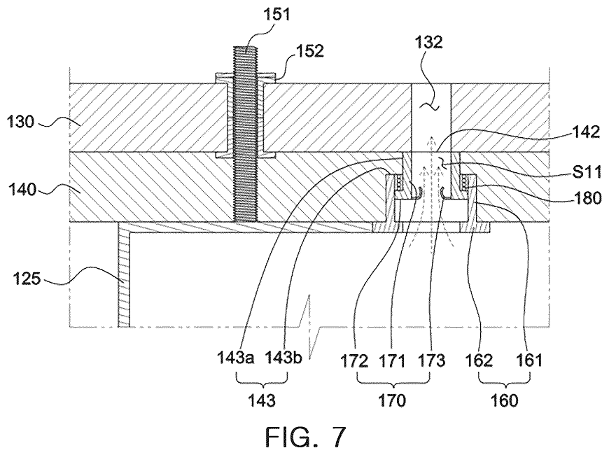

Referring to FIG. 7, when the pressure generated in the case 110 further increases in the state illustrated in FIG. 6, the breakable portion 173 formed in the second body 171 of the short-circuit member 170 may be broken, and thus the internal gas may be externally discharged through the second exhaust hole 142 and the first exhaust hole 132.

In the above-described operation of the short-circuit member 170, variables, such as a length of the second body 171 of the short-circuit member 170, physical properties such as elastic force of the elastic member 180, a melting temperature of the fuse portion formed on the current collecting member 125, and a notch design for inducing breaking of the breakable portion 173 may be adjusted, such that a condition for a rise in the short-circuit member 170, a condition of induction of a short-circuit, and a condition of breaking of the breakable portion 173 may be set in advance.

Hereinafter, other embodiments of the short-circuit member 170 will be described.

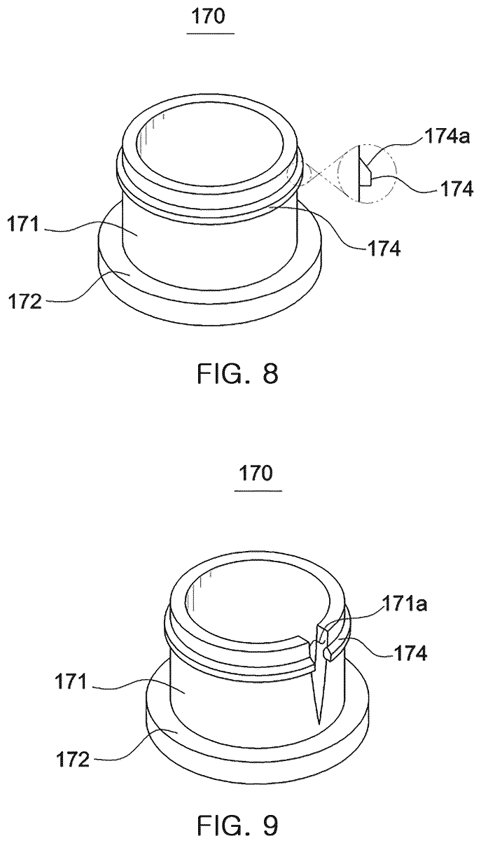

FIG. 8 is a diagram illustrating another embodiment of the short-circuit member 170 in the secondary battery 100 based on an embodiment. FIG. 9 is a diagram illustrating another embodiment of the short-circuit member 170.

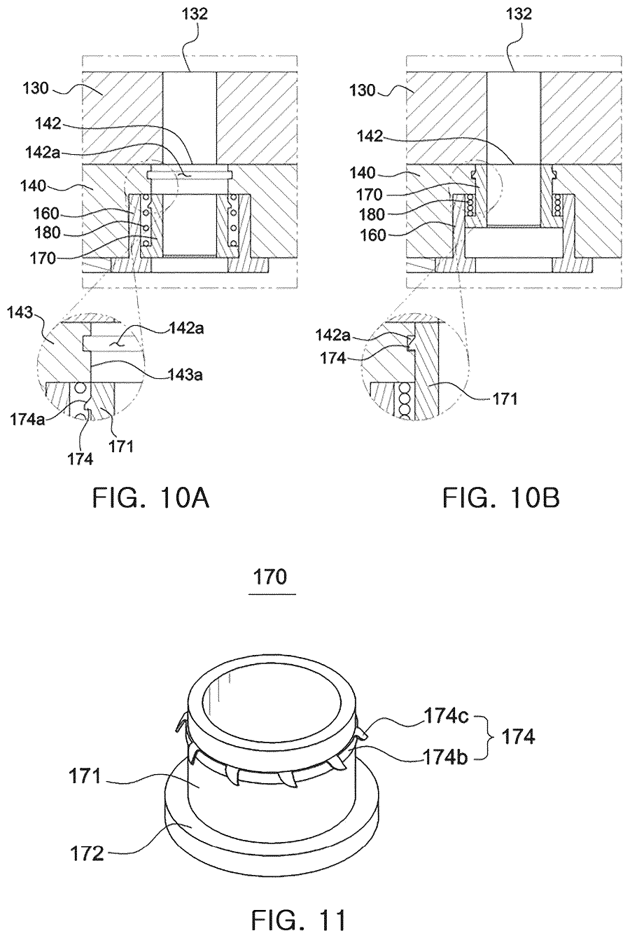

First, referring to FIG. 8, the short-circuit member 170 may further include a protrusion portion 174 coupled to an outer perimeter of the second body 171. For example, the protrusion portion 174 may have an overall ring shape. A groove (not illustrated) may be formed in the outer perimeter of the second body 171 to accommodate a portion of the protrusion portion 174. The protrusion portion 174 may be formed integrally with the second body 171. When the short-circuit member 170 rises and the upper end of the short-circuit member 170 comes into contact with the lower surface of the cap plate 130, the protrusion portion 174 may be accommodated in an accommodation groove 142a (see FIGS. 10A and 10B) provided in the insulating member 140, thereby preventing the short-circuit member 170 from falling. An upper end of the protrusion portion 174 may have an inclined surface 174a. In this case, when the short-circuit member 170 rises, the protrusion portion 174 may not be caught by the wall portion 143 of the insulating member 140 (see FIGS. 10A and 10B).

Referring to FIG. 9, at least one of the second body 171 or the protrusion portion 174 of the short-circuit member 170 may have at least one cutout portion 171a in a height direction. That is, the cutout portion 171a may be formed in the second body 171 in the height direction, in the protrusion portion 174, or in both the second body 171 and the protrusion portion 174. In connection therewith, FIG. 9 illustrates a case in which the cutout portion 171a is formed on both the second body 171 and the protrusion portion 174. In addition, FIG. 9 illustrates a case in which one cutout portion 171a is formed, but two or more cutout portions 171a may be formed. The cutout portion 171a may allow the second body 171 or the protrusion portion 174 to be slightly shrunk by external pressure, thereby allowing the protrusion portion 174 to be more easily accommodated in the accommodation groove 142a provided in the insulating member 140 when the short-circuit member 170 rises.

FIGS. 10A and 10B are cross-sectional views of operations of the short-circuit member 170 of FIG. 9. Referring to FIG. 10A, the insulating member 140 may have an accommodation groove 142a formed in the side surface 143a of the wall portion 143. The accommodation groove 142a may accommodate the protrusion portion 174 of the short-circuit member 170 therein.

Referring to FIG. 10B, as described above, the short-circuit member 170 may rise as internal pressure of the case 110 increases. In this case, the inclined surface 174a formed at the upper end of the protrusion portion 174 may guide the protrusion portion 174 not to be caught by the wall portion 143 of the insulating member 140, when the short-circuit member 170 rises. In addition, when the upper end of the short-circuit member 170 rises until the upper end of the short-circuit member 170 comes into contact with a lower surface of the cap plate 130, the protrusion portion 174 may be accommodated in the accommodation groove 142a provided in the insulating member 140. Accordingly, the short-circuit member 170 may be fixed in an elevated state, and may not fall even when the internal pressure of the case 110 decreases. When the short-circuit member 170 is fixed to the insulating member 140 in the elevated state, the short-circuit member 170 may be prevented from repeatedly rising and falling based on an increase or decrease in the internal pressure of the case 110, thereby more stably performing a short-circuit function.

FIG. 11 is a diagram illustrating another embodiment of the short-circuit member 170.

Referring to FIG. 11, the short-circuit member 170 may further include a protrusion portion 174 coupled to an outer perimeter of the second body 171. In this case, the protrusion portion 174 may include a body portion 174b and an elastic protrusion portion 174c. The body portion 174b may be coupled to the outer perimeter of the second body 171, and may have an overall ring shape. A groove (not illustrated) may be formed in the outer perimeter of the second body 171 to accommodate at least a portion of the body portion 174b. The elastic protrusion portion 174c may be formed to extend in a downward direction from an upper end of the body portion 174b to be slightly inclined. A plurality of elastic protrusion portions 174c may be formed at equal intervals along the body portion 174b, as illustrated in FIG. 11, or the number of elastic protrusion portions 174c may be formed to be greater than or less than that illustrated in FIG. 11. The elastic protrusion portion 174c may be elastically deformed in a direction closer to the body portion 174b by external force, and may be elastically restored when the external force disappears. The elastic protrusion portion 174c may allow the protrusion portion 174 to be more easily accommodated in the accommodation groove 142a provided in the insulating member 140 when the short-circuit member 170 rises, as in other embodiments.

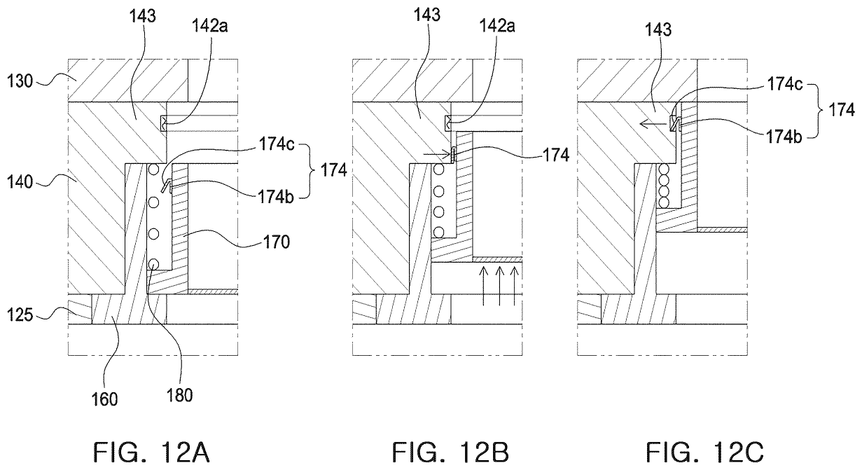

FIGS. 12A, 12B, and 12C are cross-sectional views of operations of the short-circuit member 170 of FIG. 11. Referring to FIG. 12A, the insulating member 140 may have an accommodation groove 142a formed in the side surface 143a of the wall portion 143. The accommodation groove 142a may accommodate the protrusion portion 174 of the short-circuit member 170 therein. The elastic protrusion portion 174c of the protrusion portion 174 may maintain an initial shape thereof. Referring to FIG. 12B, the short-circuit member 170 may rise as internal pressure of the case 110 increases. In this case, the elastic protrusion portion 174c of the protrusion portion 174 may be formed to extend in a downward direction from an upper end of the body portion 174b to be inclined. Thus, when the short-circuit member 170 rises, the protrusion portion 174 may be guided not to be caught by the wall portion 143 of the insulating member 140. In addition, the elastic protrusion portion 174c may be pressed by the wall portion 143 to be elastically deformed in a direction closer to the body portion 174b. Referring to FIG. 12C, when an upper end of the short-circuit member 170 rises until the upper end of the short-circuit member 170 comes into contact with a lower surface of the cap plate 130, the elastic protrusion portion 174c of the protrusion portion 174 may be positioned in the accommodation groove 142a of the insulating member 140. In addition, as external force applied to the elastic protrusion portion 174c is released, the elastically deformed shape of the elastic protrusion portion 174c may be restored to be caught in the accommodation groove 142a. Accordingly, as in other embodiments, the short-circuit member 170 may be fixed in an elevated state, and may not fall even when the internal pressure of the case 110 decreases.

Hereinafter, a secondary battery based on another embodiment of the disclosed technology will be described. The examples below may be different from the examples discussed above in terms of a guide member 260 and a short-circuit member 270, and other components in the examples below may be the same as or similar to those in the examples discussed above, and thus the guide member 260 and the short-circuit member 270 will be mainly described below. In addition, components in the examples below may be the same as or similar to those in the examples discussed above and may be denoted by the same reference numeral, and only the guide member 260 and the short-circuit member 270 are denoted by new reference numerals.

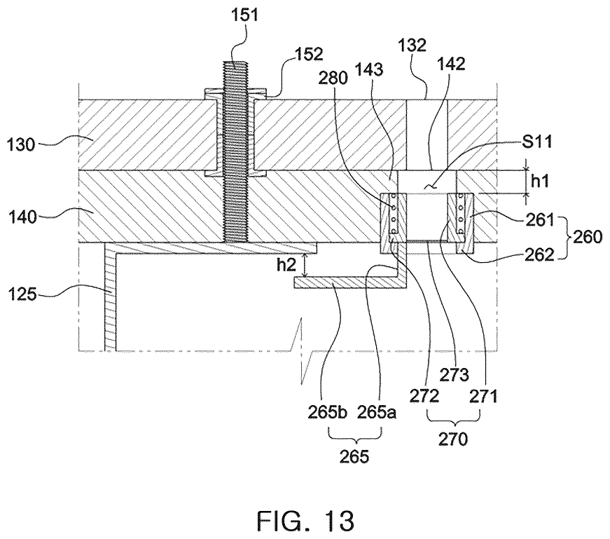

FIGS. 13 to 15 are cross-sectional views of sequential operations of a short-circuit member 270 in a secondary battery based on another embodiment.

Referring to FIG. 13, a secondary battery 200 based on some embodiments may include a guide member 260, a short-circuit member 270 and a short-circuit tab 265. In addition, the secondary battery 200 may further include an elastic member 280.

The guide member 260 may be installed in a lower portion of a second exhaust hole 142. Specifically, the guide member 260 may be installed in a second space S12 of an insulating member 140. In this case, the guide member 260 may not be formed of a conductive material, unlike the examples discussed above. The guide member 260 may include a first body 261 with a hollow structure having open upper and lower portions, and a first bottom portion 262 formed to extend in an inward direction from a lower end of the first body 261. That is, in some embodiments, the first bottom portion 262 of the guide member 260 may be formed to extend only in the inward direction from the lower end of the first body 261, unlike the examples discussed above. In addition, the first bottom portion 262 may not be connected to a current collecting member 125. As in the examples discussed above, the first bottom portion 262 may be formed to extend in inward and outward direction from the lower end of the first body 261. A portion of the first bottom portion 262, formed to extend in the inward direction from the lower end of the first body 261, may support the short-circuit member 270. The inside of the first body 261 may function as a movement path of gas or the like generated in the case 110.

The short-circuit member 270 may include a second body 271 with a hollow structure having an open upper portion, a second bottom portion 272 formed to extend in an outward direction from a lower end of the second body 271, and a breakable portion 273 formed in the second body 271. A shape of the short-circuit member 270 may be the same as or similar to that in the examples discussed above.

As in the examples discussed above, the elastic member 280 may be installed in a space provided between the inside of the first body 261 of the guide member 260 and the outside of the second body 271 of the short-circuit member 270. In this case, an upper portion of the elastic member 280 may be supported by a lower surface of a wall portion 143 of the insulating member 140, and a lower portion of the elastic member 280 may be supported by the second bottom portion 272 of the short-circuit member 270.

The short-circuit tab 265 may be formed of a conductive material, and a type of material is not limited. The short-circuit tab 265 may have one end coupled to a lower portion of the short-circuit member 270, and the other end positioned in a lower portion of the current collecting member 125. In an example, as illustrated in FIGS. 13 to 15, the short-circuit tab 265 may include a vertical member 265a coupled to the lower portion of the short-circuit member 270, the vertical member 265a extending in a downward direction by a predetermined length, and a horizontal member 265b extending toward the current collecting member 125 from a lower portion of the vertical member 265a by a predetermined length. In this case, the vertical member 265a and the horizontal member 265b may be integrally formed.

As illustrated in FIGS. 13 to 15, the vertical member 265a may be disposed on an open lower portion of the guide member 260 to be coupled to the lower portion of the short-circuit member 270. Alternatively, unlike that in the drawings, an opening (not illustrated) through which the vertical member 265a passes may be formed in the first bottom portion 262 of the guide member 260, and the vertical member 265a may pass through the opening to be coupled to the lower portion of the short-circuit member 270. The vertical member 265a may have a plate shape or a rod shape, but the disclosed technology is not limited thereto.

The horizontal member 265b may extend in a horizontal direction from the lower portion of the vertical member 265a toward the current collecting member 125. The horizontal member 265a may also have a plate shape or a rod shape, but the disclosed technology is not limited thereto.

As illustrated in FIG. 13, the short-circuit member 270 may maintain a state in which the short-circuit member 270 is pressed by the elastic member 280, and an upper end of the short-circuit member 270 may be maintained in a state of being spaced apart from a lower surface of the cap plate 130. In this case, a distance (denoted by “h1”) between the upper end of the short-circuit member 270 and the lower surface of the cap plate 130 may be approximately the same as a distance (denoted by “h2”) between a lower surface of the current collecting member 125 and the horizontal member 265b of the short-circuit tab 265.

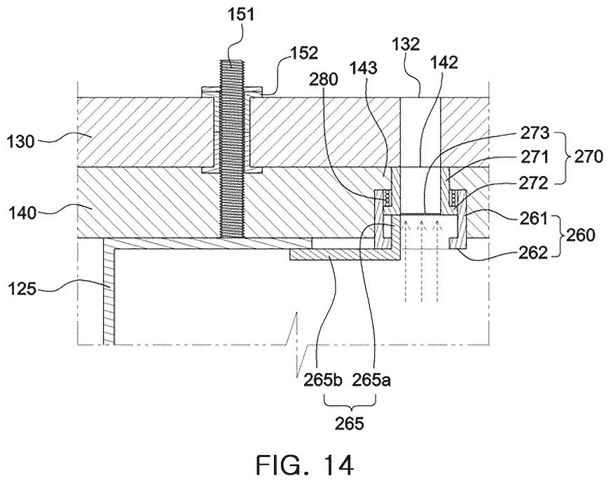

Referring to FIG. 14, when internal pressure of a case excessively increases, the short-circuit member 270 may start to rise as in the examples discussed above, and the elastic member 180 may be compressed in proportion to the rise of the short-circuit member 270. Subsequently, as the pressure generated in the case 110 increases, the short-circuit member 270 may rise until an upper end of the short-circuit member 270 comes into contact with a lower surface of the cap plate 130 exposed to the second exhaust hole 142. Furthermore, when the upper end of the short-circuit member 270 comes into contact with the lower surface of the cap plate 130, the horizontal member 265b of the short-circuit tab 265 may come into contact with the current collecting member 125. In this case, the current collecting member 125, the short-circuit tab 265, and the short-circuit member 270 may all be electrically connected to each other, and the current collecting member 125 and the cap plate 130 may have different polarities, and thus the upper end of the short-circuit member 270 may come into contact with the lower surface of the cap plate 130 and a short-circuit may be induced when the short-circuit tab 265 comes into contact with the current collecting member 125. Furthermore, when the short-circuit is induced, a large amount of current may temporarily flow, thereby generating excessive heat. In this case, when the temperature of the fuse portion formed on the current collecting member 125 or electrically connected to the current collecting member 125 exceeds a melting temperature due to the heat generated, the fuse portion may be melted to block a flow of current.

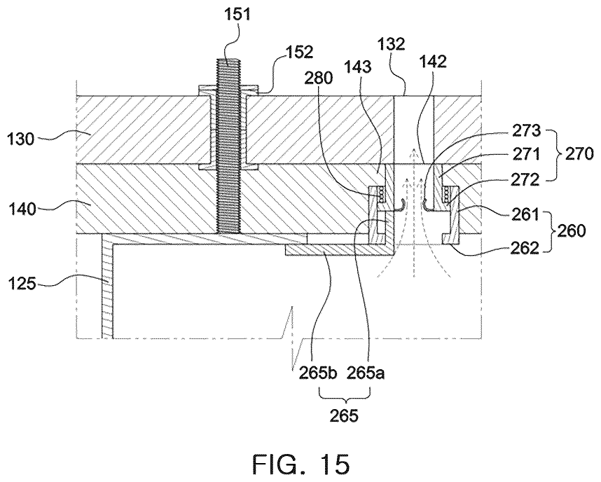

Referring to FIG. 15, when the pressure generated in the case further increases in the state illustrated in FIG. 14, the breakable portion 273 formed in the second body 271 of the short circuit member 270 may be broken, and thus the internal gas may be externally discharged through the second exhaust hole 142 and the first exhaust hole 132.

As described with reference to FIG. 8 to FIG. 12C, the short-circuit member 270 based on some embodiments may further include a protrusion portion (not illustrated) coupled to an outer perimeter of the second body 271. Various embodiments of the protrusion portion have been described above, and thus a repeated description thereof will be omitted. As described with reference to FIG. 8 to FIG. 12C, the insulating member 140 based on some embodiments may have an accommodation groove for accommodating the protrusion portion, and a repeated description thereof will be omitted.

As described above, the secondary battery 100 based on embodiments of the disclosed technology may include the short-circuit members 170 and 270 performing a short-circuit function when an abnormality occurs, and breakable portions 173 and 273 formed in the short-circuit member, the breakable portions 173 and 273 performing an internal gas emission function, such that components, performing respective functions, may not need to be additionally installed, thereby simplifying a configuration.

The disclosed technology can be implemented in making battery packs with rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery pack used in various power sources and power supplies, thereby mitigating climate changes in connection with uses of power sources and power supplies. Battery packs based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Only specific examples of implementations of certain embodiments are described. Variations, improvements and enhancements of the disclosed embodiments and other embodiments may be made based on the disclosure of this patent document.

What is claimed is:

1. A secondary battery comprising:
a case structured to accommodate an electrode assembly;
a cap plate configured to seal an opening of the case and including a first exhaust hole to allow a gas to pass through, the cap plate having a first electrical polarity for the second battery;
an insulating member disposed on a lower portion of the cap plate and including a second exhaust hole positioned to correspond to a position of the first exhaust hole to allow the gas to pass through the first and second exhaust holes, the second exhaust hole having a larger diameter than the first exhaust hole;
a current collecting member disposed on a lower portion of the insulating member and electrically connected to the electrode assembly, the current collecting member having a second electrical polarity of the secondary battery that is different from the first electrical polarity;
a guide member disposed in a lower portion of the second exhaust hole and electrically connected to the current collecting member; and
a short-circuit member including a conductive material and movably disposed in the guide member, the short-circuit member being configured to move upward to come into contact with the cap plate in response to a pressure generated within the case.

2. The secondary battery of claim 1, further comprising:
an elastic member disposed in the guide member and configured to press against the short-circuit member from above to be against the pressure generated within the case.

3. The secondary battery of claim 1, wherein the guide member includes:
a first body including open upper and lower portions; and
a first bottom portion formed to extend in both inward and outward directions from a lower end of the first body,
wherein the first bottom portion is electrically connected to the current collecting member.

4. The secondary battery of claim 3, wherein the short-circuit member includes:
a second body including an open upper portion;
a second bottom portion formed to extend in an outward direction from a lower end of the second body; and
a breakable portion formed in the second body and including a notch.

5. The secondary battery of claim 4, wherein the short-circuit member further includes a protrusion portion coupled to an outer perimeter of the second body, and
the insulating member includes an accommodation groove structured to accommodate the protrusion portion when the short-circuit member moves upward.

6. The secondary battery of claim 5, wherein at least one of the second body or the protrusion portion of the short-circuit member includes at least one cutout portion.

7. The secondary battery of claim 5, wherein the protrusion portion includes an inclined surface formed at an upper end of the protrusion portion.

8. The secondary battery of claim 5, wherein the protrusion portion includes:
a body portion coupled to an outer perimeter of the second body; and
an elastic protrusion portion extending in a downward direction at an angle from an upper end of the body portion.

9. A secondary battery comprising:
a case structured to accommodate an electrode assembly;
a cap plate configured to seal an opening of the case and including a first exhaust hole, the cap plate having a first polarity;
an insulating member disposed on a lower portion of the cap plate and including a second exhaust hole positioned to corresponding to a position of the first exhaust hole, the second exhaust hole having a larger diameter than the first exhaust hole;
a current collecting member disposed on a lower portion of the insulating member and electrically connected to the electrode assembly, the current collecting member having a second polarity that is different from the first polarity;
a guide member disposed in a lower portion of the second exhaust hole;
a short-circuit member including a conductive material and movably disposed in the guide member, the short-circuit member being configured to move upward to come into contact with the cap plate in response to a pressure generated within the case; and
a short-circuit tab including a conductive material and coupled to a lower portion of the short-circuit member, the short-circuit tab being configured to come into contact with the current collecting member when the short-circuit member comes into contact with the cap plate.

10. The secondary battery of claim 9, further comprising:
an elastic member disposed in the guide member and configured to press against the short-circuit member from above.

11. The secondary battery of claim 9, wherein the guide member includes:
a first body including open upper and lower portions; and
a first bottom portion formed to extend in an inward direction from a lower end of the first body.

12. The secondary battery of claim 11, wherein the short-circuit member includes:
a second body including an open upper portion;
a second bottom portion formed to extend in an outward direction from a lower end of the second body; and
a breakable portion formed in the second body and including a notch.

13. The secondary battery of claim 12, wherein the short-circuit member further includes a protrusion portion coupled to an outer perimeter of the second body, and
the insulating member includes an accommodation groove structured to accommodate the protrusion portion when the short-circuit member moves upward.

14. The secondary battery of claim 13, wherein at least one of the second body or the protrusion portion of the short-circuit member includes at least one cutout portion.

15. The secondary battery of claim 13, wherein the protrusion portion includes an inclined surface formed at an upper end of the protrusion portion.

16. The secondary battery of claim 13, wherein the protrusion portion includes:
a body portion coupled to an outer perimeter of the second body; and
an elastic protrusion portion extending in a downward direction at an angle from an upper end of the body portion.
